(19) United States
(12) Patent Application Publication
(10) Pub. No.: US 2020/0050700 A1
(43) Pub. Date: Feb. 13, 2020

(54) PREDICTING ASPECTS OF PANEL DISCUSSIONS

(71) Applicant: International Business Machines Corporation, Armonk, NY (US)

(72) Inventors: Sarbajit K. Rakshit, Kolkata (IN); Gopal Bhageria, Kolkata (IN); Rudranil Das Gupta, Kolkata (IN); Diptiman Dasgupta, Kolkata (IN)

(21) Appl. No.: 16/100,672

(22) Filed: Aug. 10, 2018

(51) Int. Cl. G06F 17/30; G06Q 50/00

(52) U.S. Cl. CPC G06F 17/30699; G06Q 50/01; G06F 17/30867; G06F 17/30309

(57) ABSTRACT

A method, system and computer program product for predicting a range of questions that will come up in a panel discussion are disclosed. In an embodiment, the method comprises receiving, at one or more processor units of a computer system, input identifying a topic and panelists for the panel discussion; based on the identified topic and the panelists, predicting, by the one or more processor units, audience members for the panel discussion; and identifying, by the one or more processor units, a knowledge level of the audience members and an interaction between the panelists and the audience. Based on the identified topic and panelists, the predicted audience members, and the identified knowledge level of the audience and the interaction between the panelists and the audience, a range of questions are predicted, by the one or more processor units, from the audience during the panel discussion.

### BACKGROUND

This invention, generally, relates to predicting aspects of panel discussions, and more specifically, to predicting possible questions or ranges of questions that may come up during a panel discussion.

A panel discussion, or simply a panel, involves a group of people gathered to discuss a topic in front of an audience, typically at scientific, business or academic conferences, fan conventions, and on television shows. Panels usually include a moderator who guides the discussion and sometimes elicits audience questions, with the goal of being informative and entertaining.

In a panel discussion, the topic is usually fixed, and the participating panelists discuss the topic among themselves and often the audience is also involved in the discussion. In many panel discussions, questions may be raised that are not completely or adequately answered, and topics may come up that are not fully explained or clarified.

### SUMMARY

Embodiments of the invention provide a method, system and compute program product for predicting a range of questions that will come up in a panel discussion. In an embodiment, the method comprises receiving, at one or more processor units of a computer system, input identifying a topic and panelists for the panel discussion; based on the identified topic and the panelists, predicting, by the one or more processor units of the computer system, audience members for the panel discussion; and identifying, by the one or more processor units of the computer system, a knowledge level of the audience members and an interaction between the panelists and the audience members. Based on the identified topic and panelists, the predicted audience members, and the identified knowledge level of the audience members and the interaction between the panelists and the audience members, a range of questions are predicted, by the one or more processor units, from the audience members during the panel discussion.

In embodiments of the invention, a software application or program installed in a server predicts the audiences of any panel discussion meetings and identifies their knowledge level and historical interactions and identifies ranges of questions that may come up during the panel discussions.

In embodiments of the invention, based on the selected topic, selected panelists and predicted audience, the method and system predict different types of discussion contents, and possible ranges of questions, and accordingly identifies possible unanswered questions or discussion contents during the panel discussion.

In embodiments of the invention, the method and system categorize the predicted unanswered questions, topics, and other items, and accordingly searches for additional subject matter experts (SMEs) or panelists who might answer those questions. In this way, the organizer of the panel discussion has an option to invite additional panelists or audience members who might add value to the panel discussion in those areas.

In embodiments of the invention, using cognitive techniques, the method and system also look for earlier discussions that may have taken place on the same topic and that are available in the social media or other repositories, and the method and system may get answers or other information from the social media or other repositories.

### BRIEF DESCRIPTION OF THE SEVERAL VIEWS OF THE DRAWINGS

FIG. 1 is a diagram representing a panel discussion, including panelists, audience members and communications among and between the participants.

FIG. 2 is a diagram representing a predicted discussion chain during a panel discussion.

FIG. 3 shows the implementation steps in an embodiment of the invention.

FIG. 4 illustrates information that may b e obtained about a panelist from social media.

FIG. 5 shows a networked computing system in which embodiments of the invention may be implemented.

FIG. 6 illustrates details of a computing device that may be used in the environment shown in FIG. 5.

### DETAILED DESCRIPTION

This invention, generally, relates to predicting aspects of panel discussions, and more specifically, to predicting possible questions or ranges of questions that may come up during a panel discussion. As mentioned above, in a panel discussion, the topic is usually fixed, and the participating panelists discuss the topic among themselves and often the audience is also involved in the discussion. In many panel discussions, questions may be raised that are not completely or adequately answered, and topics may come up that are not fully explained or clarified.

There is, thus a need for predicting a range of questions that may come up during a panel discussion, for predicting audience profiles and panelist profiles, and for adding one or more panelists to an initially selected group of panelists. For example, in a scientific panel discussion, it might be predicted that some scientific contextually related legal and political questions may come up, and so the organizer of the panel discussion might want to add panelists having legal and political backgrounds related to the topic of the panel discussion.

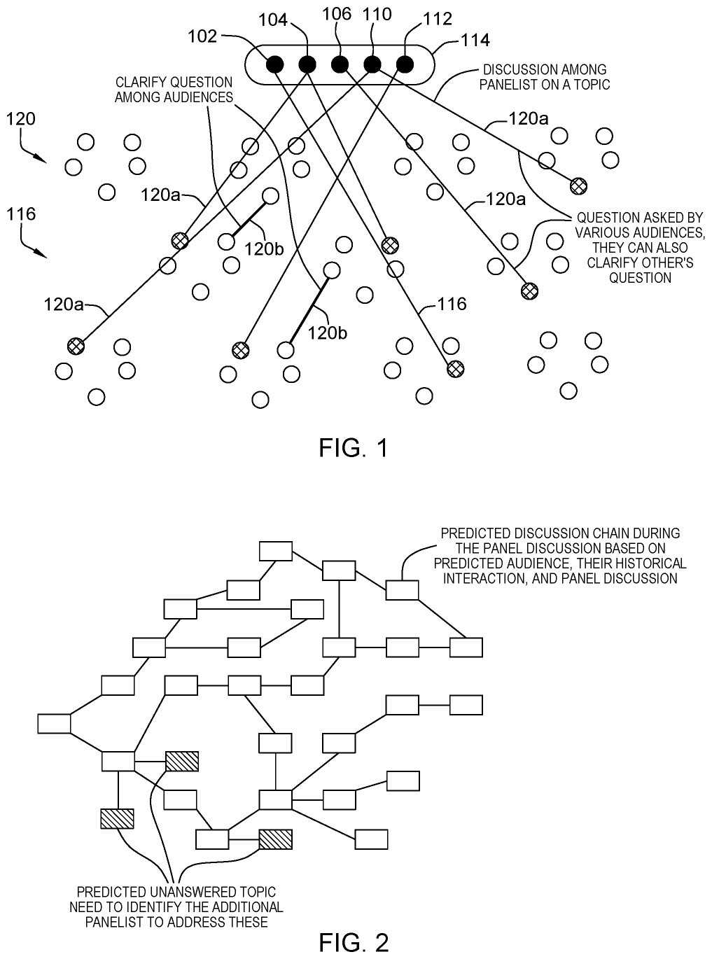

FIG. 1 is a diagram that represents a panel discussion. Nodes 102, 104, 106, 110 and 112 represent the panelists, nodes 114 represent the audience members, links 116 represent remarks or comments among the panel members, and links 120 represent remarks or comments involving the audience. For example, links 120a represent questions asked by audience members, and links 120b represent comments or remarks made by audience members that are directed to or are in reply to comments or remarks made by other audience members.

In this represented panel discussion, the participating panelists discuss among themselves around the topic and also address questions and remarks from the audience. In this panel discussion, one audience member can also reply to other audience members. During this session, questions might be asked that are unanswered or not fully answered, and topics might come up that are not adequately or fully explained. If the possible range of questions that may come up can be predicted, or if discussion content that could not be adequately addressed or clarified can be predicted, additional panelists or audience members can be invited to participate in the panel discussion.

FIG. 2 is a representation of a predicted discussion topic chain during a panel discussion, considering the current panelists, selection of topic, audience members and their knowledge levels, and predicted range of questions. Although it may be difficult or impossible to predict exact questions, a set or range of possible questions can be developed.

Embodiments of the invention compare this possible set or range of questions against the profile of each panelist and the audience to identify who can address the questions. Embodiments of the invention identify predicted questions that might be unanswered and content that might be unanswered or not adequately discussed, and accordingly, identify potential additional panelists to address those questions and topics.

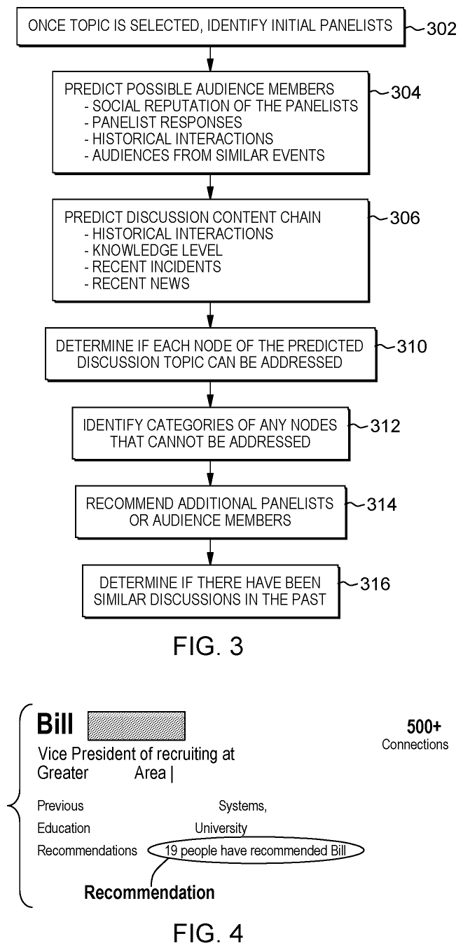

FIG. 3 illustrates an implementation of an embodiment of the invention. As represented at 302, once a topic is selected for the panel discussion, the organizer also identifies the initial panelists. Based on the selected topic and initial list of panelists, embodiments of the invention, at 304, predict the possible audience members based on a number of parameters related to the panelists and the audience.

These parameters may include the social reputation of the initially selected panelists. This reputation may be identified, for example, based on the contribution of the participating panelists in social media, the number of followers, and the number of recommendations. FIG. 4 shows an example of how a determination of a social reputation of a panelist may be made. A number of social media sites provide information about a person including current and past employment information and educational information. Various social media sites also give an indication of a social or business reputation of the person. In the example of FIG. 4, this indication is referred to as “recommendations.”

The prediction of the possible audience members may also take into account how many times the panelists have responded on various topics in public blogs, and any historical interaction among the participating panelists. The prediction may also be based on identification of audience members who have attended similar events and their profiles, and knowledge level on various topics. For example, participating audience members' social media site profiles' can be checked, and other information may be used.

As represented at 306 in FIG. 3, based on the predicted audience members, and the initially selected panelists and the selected topic, embodiments of the invention predict the discussion content chain or the possible ranges of discussions that may happen at the panel discussion. While deriving the discussion content chain, embodiments of the invention consider the historical interaction of different predicted audience members and the initial panelists, and the knowledge level and interests of predicted audience members and the initial panelists. Embodiments of the invention may also consider recent incidents, the social network contributions of the predicted audience members and the initial panelists, recent news related to the discussion topics, and other information.

At 310, embodiments of the invention, predict the discussion chain and, accordingly, determine if each node of the predicted discussion topic can be addressed by the initially selected panelists and/or audience members. If the method and system find one or more discussion chain nodes that will not be adequately addressed or clarified with the resent panelists, and/or audience members, then, at 312, the method and system identifies the categories of such nodes. At 314, the method and system recommend additional panelists or invites additional audience members to address any such questions or topics that are raised. The program may use cognitive techniques and analytics to determine if there have been similar discussions in the past that are close to the topic of this discussion, and then get answers to similar questions from those previous discussions. Those answers can be directly given in the panel discussion.

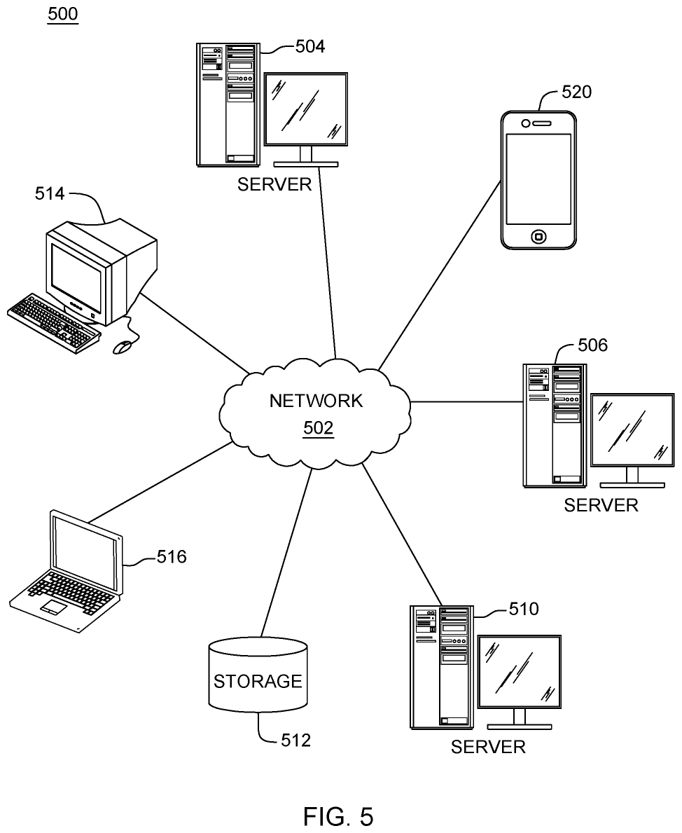

FIG. 5 depicts a pictorial representation of a networked computer system 500 in which embodiments of this invention may be implemented. Networked system 500 includes a network 502, which is the medium used to provide communications links between various devices and computers connected together within the networked system. Network 502 may include connections, such as wire, wireless communication links, or fiber optic cables, and network 502 may also be the Internet.

In the depicted example, servers 504, 506 and 510 are connected to network 502 along with storage unit 512. In addition, computing devices 514, 516 and 520 are connected to network 502. These computing devices 514, 516 and 520 may be, for example, personal computers, workstations, laptops, mobile computers or other computing devices.

Networked system 500 may include additional servers, computers, and other devices not shown. Networked system 500 may be implemented as a number of different types of networks, such as for example, the Internet, an intranet, a local area network (LAN), or a wide area network (WAN). FIG. 5 is intended as an example, and not as an architectural limitation for the invention.

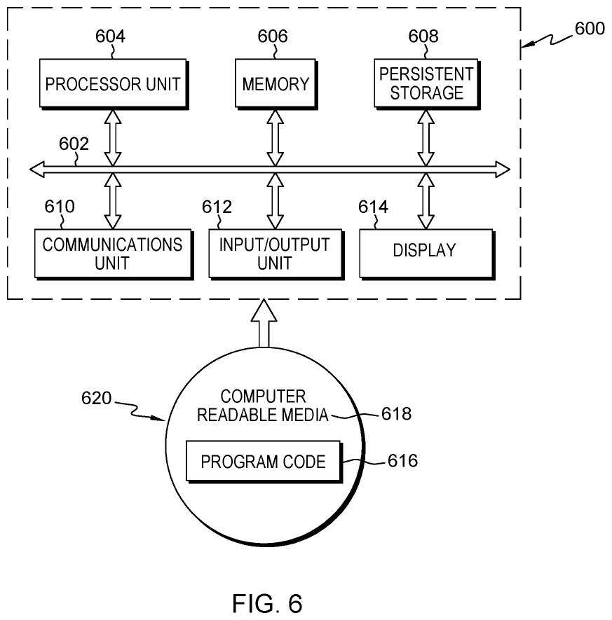

With reference now to FIG. 6, a block diagram of a data processing system 600 is shown. Data processing system 600 is an example of a computer, such as servers 504, 506 and, or computing devices 514, 516 and 520 in FIG. 5. In this illustrative example, data processing system 600 includes communications fabric 602, which provided communications between processor unit 604, memory 606, persistent storage 608, communications unit 610, input/output (I/O) unit 612, and display 614.

Processor unit 604 serves to execute instructions for software that may be loaded into memory 606. Processor unit 604 may be a set of one or more processors or may be a multi-processor core, depending on the particular implementation. Memory 606 and persistent storage 608 are examples of storage devices. Memory 606, in these examples, may be a random access memory or any other suitable volatile or non-volatile storage device. Persistent storage 608 may take various forms depending on the particular implementation. For example, persistent storage 608 may be a hard drive, a flash memory, a rewritable optical disk, a rewritable magnetic tape, or some combination of the above.

Communications unit 610, in these examples, provides for communications with other data processing systems or devices. In these examples, communications unit 610 is a network interface card. Communications unit 610 may provide communications through the use of either or both physical and wireless communications links. Input/output unit 612 allows for input and output of data with other devices that may be connected to data processing system 600. For example, input/output unit 612 may provide a connection for user input through a keyboard and mouse. Further, input/output unit 612 may send output to a printer. Display 614 provides a mechanism to display information to a user.

Those of ordinary skill in the art will appreciate that the hardware in FIGS. 5 and 6 may vary depending on the implementation. Other internal hardware or peripheral devices, such as flash memory, equivalent non-volatile memory, or optical disk drives and the like, may be used in addition to or in place of the hardware depicted in FIGS. 5 and 6.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

While it is apparent that embodiments of the invention herein disclosed are well calculated to achieve the features discussed above, it will be appreciated that numerous modifications and embodiments may be devised by those skilled in the art, and it is intended that the appended claims cover all such modifications and embodiments as fall within the true spirit and scope of the present invention.

1. A computer-implemented method of predicting a range of questions that will come up in a panel discussion, the method comprising:
receiving, at one or more processor units of a computer system, input identifying a topic and panelists for the panel discussion;
based on the identified topic and the panelists, predicting, by the one or more processor units of the computer system, audience members for the panel discussion;
identifying, by the one or more processor units of the computer system, a knowledge level of the audience members and an interaction between the panelists and the audience members; and
based on the identified topic and panelists, the predicted audience members, and the identified knowledge level of the audience members and the interaction between the panelists and the audience members, predicting, by the one or more processor units, a range of questions from the audience members during the panel discussion.

2. The method according to claim 1, wherein the predicting a range of questions from the audience members includes predicting ones of the questions that will not be answered at the panel discussion.

3. The method according to claim 2, further comprising searching for one or more additional panelists based on the predicted questions that will not be answered at the panel discussion.

4. The method according to claim 1, further comprising:
predicting discussion content that will not be explained at the panel discussion according to a defined procedure; and
searching for one or more additional panelists based on the predicted discussion content that will not be explained at the panel discussion according to the defined procedure.

5. The method according to claim 1, wherein the identifying an interaction between the panelists and the audience members includes deriving, by the one or more processor units, a discussion content chain that may occur during the panel discussion.

6. The method according to claim 1, wherein the predicting audience members includes predicting the audience members based on defined social reputations of the panelists.

7. The method according to claim 6, wherein the predicting audience members further includes predicting the audience members based on identified communications from the panelists about the topic.

8. The method according to claim 7, wherein the predicting audience members further includes predicting the audience members based on historical interactions among the panelists.

9. The method according to claim 8, wherein the predicting audience members further includes predicting audience members based on identification of people who have attended specified events prior to the panel discussion.

10. The method according to claim 1, wherein:
the panel discussion is a currently planned panel discussion; and
the predicting a range of questions from the audience members includes using cognitive techniques and analytics to identify other panel discussions prior to and having defined similarities to the currently planned panel discussion, and to get answers to questions having defined similarities to the questions predicted from the audience members of the currently planned panel discussion.

11. A computer system for predicting a range of questions that will come up in a panel discussion, the computer system comprising:
a memory for holding data; and
one or more processor unit operatively connected to the memory for sending data to and receiving data from the memory, the one or more processor units being configured for:
receiving input identifying a topic and panelists for the panel discussion;
based on the identified topic and the panelists, predicting audience members for the panel discussion;
identifying a knowledge level of the audience members and an interaction between the panelists and the audience members; and
based on the identified topic and panelists, the predicted audience members, and the identified knowledge level of the audience members and the interaction between the panelists and the audience members, predicting a range of questions from the audience members during the panel discussion.

12. The computer system according to claim 11, wherein the predicting a range of questions from the audience members includes:
predicting discussion content that will not be explained at the panel discussion according to a defined procedure; and
searching for one or more additional panelists based on the predicted discussion content that will not be explained at the panel discussion according to the defined procedure.

13. The computer system according to claim 11, wherein the identifying an interaction between the panelists and the audience members includes deriving a discussion content chain that may occur during the panel discussion.

14. The computer system according to claim 11, wherein the predicting audience members includes predicting the audience members based on defined social reputations of the panelists and identified communications from the panelists about the topic.

15. The computer system according to claim 11, wherein:
the panel discussion is a currently planned panel discussion; and
the predicting a range of questions from the audience members includes using cognitive techniques and analytics to identify other panel discussions prior to and having defined similarities to the currently planned panel discussion, and to get answers to questions having defined similarities to the questions predicted from the audience members of the currently planned panel discussion.

16. A computer program product for predicting a range of questions that will come up in a panel discussion, the computer program product comprising:
a computer readable storage medium having program instructions embodied therein, the program instructions executable by a computer to cause the computer to perform the method of:
receiving, at the computer, input identifying a topic and panelists for the panel discussion;
based on the identified topic and the panelists, predicting, by the computer, audience members for the panel discussion;
identifying, by the computer, a knowledge level of the audience members and an interaction between the panelists and the audience members; and
based on the identified topic and panelists, the predicted audience members, and the identified knowledge level of the audience members and the interaction between the panelists and the audience members, predicting, by the computer, a range of questions from the audience members during the panel discussion.

17. The computer program product according to claim 16, wherein the predicting a range of questions from the audience members includes:
predicting ones of the questions that will not be answered at the panel discussion; and
searching for one or more additional panelists based on the predicted questions that will not be answered at the panel discussion.

18. The computer program product according to claim 16, wherein the identifying an interaction between the panelists and the audience members includes deriving a discussion content chain that may occur during the panel discussion.

19. The computer program product according to claim 16, wherein the predicting audience members includes predicting the audience members based on historical interactions among the panelists and
identification of people who have attended specified events prior to the panel discussion.

20. The computer program product according to claim 16, wherein:
the panel discussion is a currently planned panel discussion; and
the predicting a range of questions from the audience members includes using cognitive techniques and analytics to identify other panel discussions prior to and having defined similarities to the currently planned panel discussion, and to get answers to questions having defined similarities to the questions predicted from the audience members of the currently planned panel discussion.
